(19) United States
(12) Patent Application Publication
(10) Pub. No.: US 2014/0095698 A1
(43) Pub. Date: Apr. 3, 2014

(54) MONITORING AND REPORTING RELEVANT ACTIVITIES

(71) Applicant: SYR TECHNOLOGY, LLC, LOS ANGELES, CA (US)

(72) Inventor: JONATHAN GRIER, LAKEWOOD, NJ (US)

(73) Assignee: SYR TECHNOLOGY, LLC, LOS ANGELES, CA (US)

(21) Appl. No.: 13/774,303

(22) Filed: Feb. 22, 2013

Related U.S. Application Data
(60) Provisional application No. 61/707,125, filed on Sep. 28, 2012.

(51) Int. Cl. H04L 12/24

(52) U.S. Cl. CPC H04L 41/5032
USPC 709/224

(57) ABSTRACT

Computer program products, methods, systems, apparatus, and computing entities are provided for monitoring and reporting user activities. In one embodiment, a monitoring application executing on a monitoring computing entity can record information/data about a user's Internet activities or computing-related activities (e.g., including content accessed by the user). Then, a reporting application can generate reports of the user's Internet activities or computing-related activities (e.g., including content accessed by the user).

### CROSS-REFERENCE TO RELATED APPLICATIONS

This application claims priority to U.S. Application No. 61/707,125 filed on Sep. 28, 2012, which is hereby incorporated herein in its entirety by reference.

### BACKGROUND

Currently, real-world and computing-related activities and reports are often disregarded because they include false alarms and noise or otherwise make incorrect judgments about behavior and activities. Such reports often fail to provide use useful, actionable information that can be easily understood by interested parties. Thus, a need exists to provide a solution that monitors various activities and/or reports relevant information/data regarding the same by providing an accurate report of such activities, highlighting relevant changes, and portraying nuances and history as needed to allow interested parties to make informed decisions.

### BRIEF SUMMARY

In general, embodiments of the present invention provide methods, apparatus, systems, computing entities, computing entities, and/or the like for monitoring and reporting relevant user information/data.

In accordance with one aspect, a method for monitoring and reporting user activities is provided. In one embodiment, the method comprises (1) receiving data associated with a plurality of computing-related activities, wherein each of the plurality computing-related activities is associated with a classification from a plurality of classifications; (2) generating a report for a time period based at least in part on the plurality of computing-related activities, wherein generating the report comprises: (a) aggregating each of the computing-related activities into the respective plurality of classifications, (b) for each of the respective plurality of classifications, aggregating the corresponding data associated with the plurality of computing-related activities for the classification by source, and (c) generating an object for each of the respective plurality of classifications, wherein each object comprises data associated with the corresponding computing-related activities for the classification aggregated by source, and (3) providing the report.

In accordance with another aspect, a computer program product for monitoring and reporting user activities is provided. The computer program product may comprise at least one computer-readable storage medium having computer-readable program code portions stored therein, the computer-readable program code portions comprising executable portions configured to (1) receive data associated with a plurality of computing-related activities, wherein each of the plurality computing-related activities is associated with a classification from a plurality of classifications; (2) generate a report for a time period based at least in part on the plurality of computing-related activities, wherein generating the report comprises: (a) aggregating each of the computing-related activities into the respective plurality of classifications, (b) for each of the respective plurality of classifications, aggregating the corresponding data associated with the plurality of computing-related activities for the classification by source, and (c) generating an object for each of the respective plurality of classifications, wherein each object comprises data associated with the corresponding computing-related activities for the classification aggregated by source, and (3) provide the report.

In accordance with yet another aspect, an apparatus comprising at least one processor and at least one memory including computer program code is provided. In one embodiment, the at least one memory and the computer program code may be configured to, with the processor, cause the apparatus to (1) receive data associated with a plurality of computing-related activities, wherein each of the plurality computing-related activities is associated with a classification from a plurality of classifications; (2) generate a report for a time period based at least in part on the plurality of computing-related activities, wherein generating the report comprises: (a) aggregating each of the computing-related activities into the respective plurality of classifications, (b) for each of the respective plurality of classifications, aggregating the corresponding data associated with the plurality of computing-related activities for the classification by source, and (c) generating an object for each of the respective plurality of classifications, wherein each object comprises data associated with the corresponding computing-related activities for the classification aggregated by source, and (3) provide the report.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is an overview of a system that can be used to practice embodiments of the present invention.

FIG. 2 is an exemplary schematic diagram of a remote computing entity according to one embodiment of the present invention.

FIG. 3 is a flowchart illustrating operations and processes that can be used in accordance with various embodiments of the present invention.

FIGS. 4, 5A, 5B, 6A, 6B, 7, and 8 show exemplary inputs and outputs in accordance with various embodiments of the present invention.

### DETAILED DESCRIPTION

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

### I. COMPUTER PROGRAM PRODUCTS, METHODS, AND COMPUTING ENTITIES

Embodiments of the present invention may be implemented in various ways, including as computer program products. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory, multimedia memory cards (MMC), secure digital (SD) memory cards, Memory Sticks, and/or the like. Further, a non-volatile computer-readable storage medium may also include conductive-bridging random access memory (CBRAM), phase-change random access memory (PRAM), ferroelectric random-access memory (FeRAM), resistive random-access memory (RRAM), Silicon-Oxide-Nitride-Oxide-Silicon memory (SONOS), racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Rambus in-line memory module (RIMM), dual in-line memory module (DIMM), single in-line memory module (SIMM), video random access memory VRAM, cache memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing entities, computing entities, and/or the like. As such, embodiments of the present invention may take the form of an apparatus, system, computing entity, computing entity, and/or the like executing instructions stored on a computer-readable storage medium to perform certain steps or operations. However, embodiments of the present invention may also take the form of an entirely hardware embodiment performing certain steps or operations.

Embodiments of the present invention are described below with reference to block diagrams and flowchart illustrations. Thus, it should be understood that each block of the block diagrams and flowchart illustrations, respectively, may be implemented in the form of a computer program product, an entirely hardware embodiment, a combination of hardware and computer program products, and/or apparatus, systems, computing entities, computing entities, and/or the like carrying out instructions on a computer-readable storage medium for execution. Such embodiments can produce specifically-configured machines performing the steps or operations specified in the block diagrams and flowchart illustrations. Accordingly, the block diagrams and flowchart illustrations support various combinations of embodiments for performing the specified steps or operations.

### II. EXEMPLARY SYSTEM ARCHITECTURE

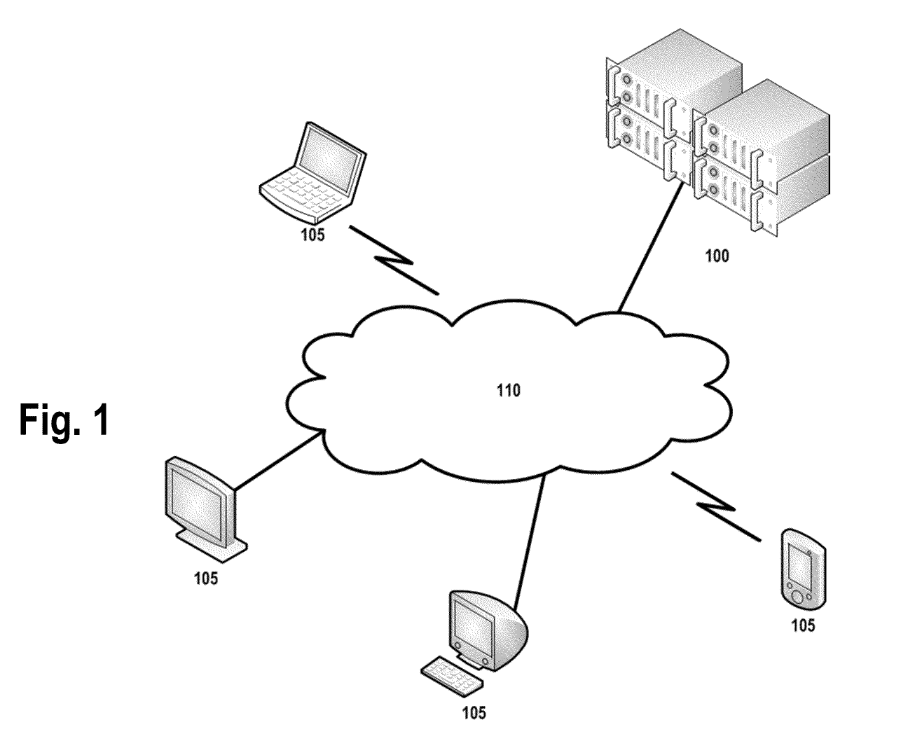

FIG. 1 provides an illustration of an exemplary embodiment of the present invention. As shown in FIG. 1, this particular embodiment may include one or more remote computing entities 100, one or more user computing entities 105, and one or more networks 110. Each of these components may be in direct or indirect communication with, for example, one another over the same or different wired or wireless networks. Additionally, while FIG. 1 illustrates the various system entities as separate, standalone entities, the various embodiments are not limited to this particular architecture.

### 1. Exemplary Remote Computing Entity

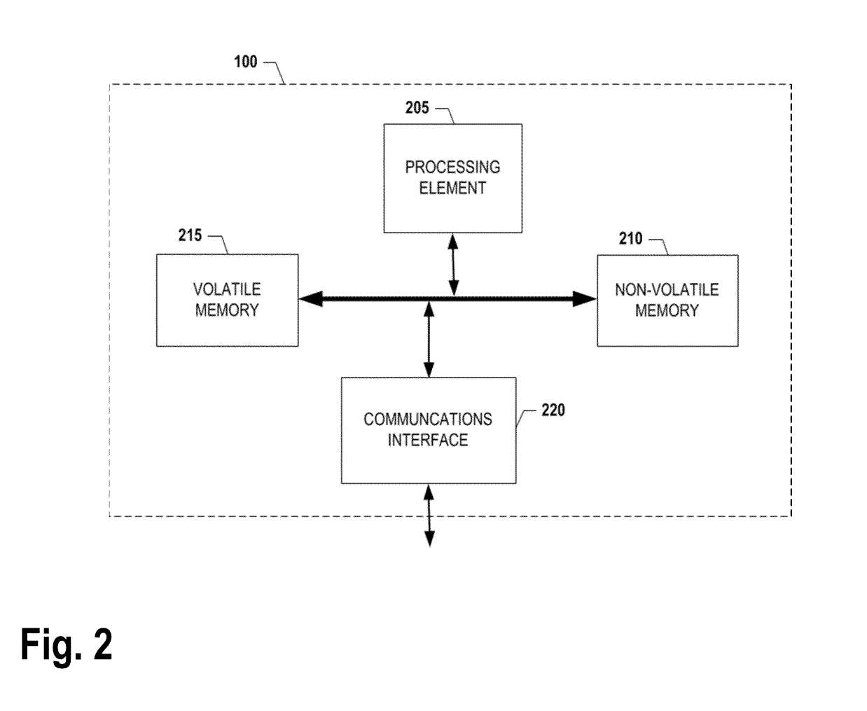

FIG. 2 provides a schematic of a remote computing entity 100 according to one embodiment of the present invention. The term remote may refer to any entity that is physically located remotely from another computing entity or simply as being separate from another computing entity (but located close in terms of physical proximity). In general, the term computing entity may refer to, for example, one or more computers, computing entities, computing entities, mobile phones, desktops, tablets, notebooks, laptops, distributed systems, servers, blades, gateways, switches, processing devices, processing entities, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the remote computing entity 100 may also include one or more communications interfaces 220 for communicating with or monitoring various computing entities, such as by communicating data, content, information, and/or similar terms used herein interchangeably that can be transmitted, received, operated on, processed, displayed, stored, and/or the like. For instance, the remote computing entity 100 may communicate with user computing entities 105 to monitor Internet activities or computing-related activities and/or report relevant data regarding the same.

As shown in FIG. 2, in one embodiment, the remote computing entity 100 may include or be in communication with one or more processing elements 205 (also referred to as processors, processing circuitry, and/or similar terms used herein interchangeably) that communicate with other elements within the remote computing entity 100 via a bus, for example. As will be understood, the processing element 205 may be embodied in a number of different ways. For example, the processing element 205 may be embodied as one or more complex programmable logic devices (CPLDs), microprocessors, multi-core processors, coproces sing entities, application-specific instruction-set processors (ASIPs), and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the remote computing entity 100 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 210 as described above, such as hard disks, ROM, PROM, EPROM, EEPROM, flash memory, MMCs, SD memory cards, Memory Sticks, CBRAM, PRAM, FeRAM, RRAM, SONOS, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like. Such code may include a monitoring application and/or reporting application executed to monitor Internet activities or computing-related activities and/or report relevant data regarding the same. The term database, database instance, database management system, and/or similar terms used herein interchangeably may refer to a structured collection of records or data that is stored in a computer-readable storage medium, such as via a relational database, hierarchical database, and/or network database.

In one embodiment, the remote computing entity 100 may further include or be in communication with volatile media (also referred to as volatile storage, memory, memory storage, memory circuitry and/or similar terms used herein interchangeably). In one embodiment, the volatile storage or memory may also include one or more volatile storage or memory media 215 as described above, such as RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the remote computing entity 100 with the assistance of the processing element 205 and operating system, such as monitoring and/or reporting about Internet activities or computing-related activities.

As indicated, in one embodiment, the remote computing entity 100 may also include one or more communications interfaces 220 for communicating with or monitoring various computing entities, such as by communicating data, content, information, and/or similar terms used herein interchangeably that can be transmitted, received, operated on, processed, displayed, stored, and/or the like. For instance, the remote computing entity 100 may communicate with user computing entities 105 (e.g., operated by users) to monitor Internet activities or computing-related activities and/or report relevant data regarding the same regarding the same. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the remote computing entity 100 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), 802.16 (WiMAX), ultra wideband (UWB), infrared (IR) protocols, Bluetooth protocols, wireless universal serial bus (USB) protocols, and/or any other wireless protocol.

Although not shown, the remote computing entity 100 may include or be in communication with one or more input elements, such as a keyboard input, a mouse input, a touch screen/display input, audio input, pointing device input, joystick input, keypad input, and/or the like. The remote computing entity 100 may also include or be in communication with one or more output elements (not shown), such as audio output, video output, screen/display output, motion output, movement output, and/or the like.

As will be appreciated, one or more of the remote computing entity's 100 components may be located remotely from other remote computing entity 100 components, such as in a distributed system. Furthermore, one or more of the components may be combined and additional components performing functions described herein may be included in the remote computing entity 100. Thus, the remote computing entity 100 can be adapted to accommodate a variety of needs and circumstances.

### 2. Exemplary Monitoring Computing Entity

A user may be an individual, a family, a company, an organization, an entity, a department within an organization, a representative of an organization and/or person, and/or the like using a computing entity to access the Internet. To do so, a user may operate a monitoring computing entity 105 executing a monitoring application and/or a reporting application. To do so, the monitoring computing entity 105 may include one or more components that are functionally similar to those of the remote computing entity 100. For example, in one embodiment, each monitoring computing entity 105 may include one or more processing elements, one or more display device/input devices, volatile and non-volatile storage or memory, and/or one or more communications interfaces. These architectures are provided for exemplary purposes only and are not limiting to the various embodiments. The term computing entity may refer to one or more computers, computing entities, computing entities, mobile phones, desktops, tablets, notebooks, laptops, distributed systems, servers, blades, gateways, switches, processing devices, processing entities, relays, routers, network access points, base stations, the like, and/or any combination of devices or entities adapted to perform the functions described herein.

### III. EXEMPLARY SYSTEM OPERATION

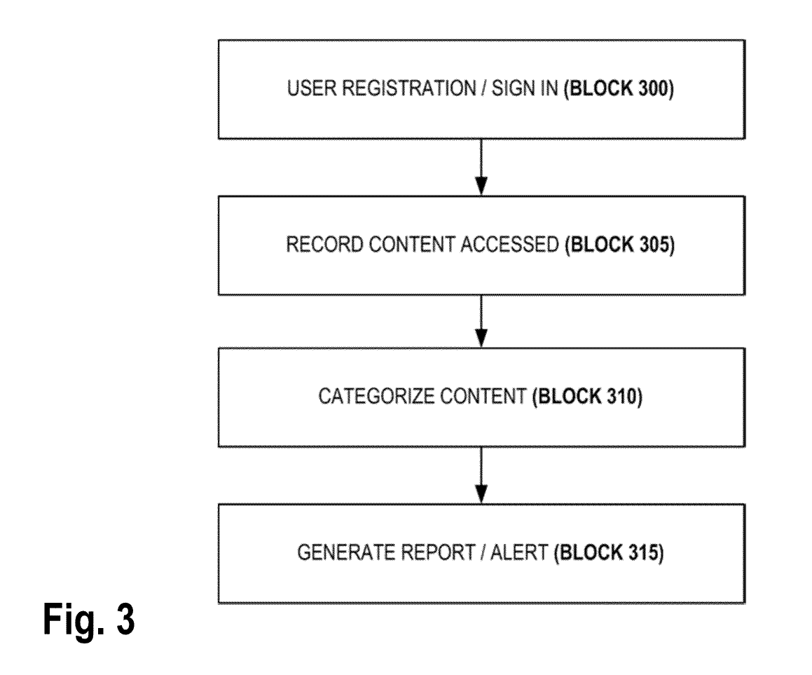

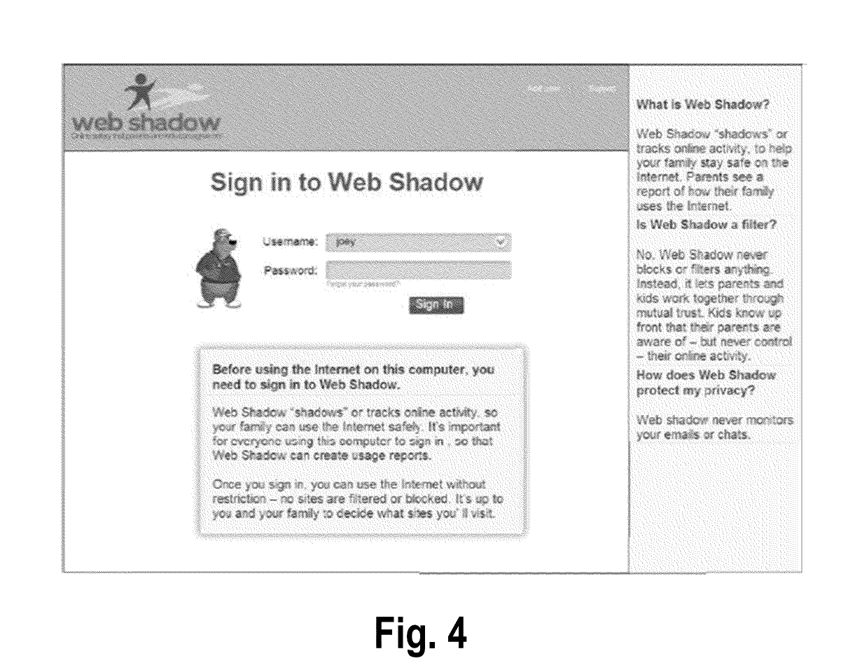

Reference will now be made to FIGS. 3, 4, 5A, 5B, 6A, 6B, 7, and 8. FIG. 3 is a flowchart illustrating operations and processes that may be performed for monitoring and reporting relevant user information/data. FIGS. 4, 5A, 5B, 6A, 6B, 7, and 8 show exemplary inputs and outputs in accordance with various embodiments of the present invention.

### 1. Brief Overview

In one embodiment, the concepts described herein can be used to provide an awareness of the Internet activities or computing-related activities of users (e.g., children, employees, etc.) to interested parties (e.g., parents, employers, etc.). Further, the concepts can be used for security monitoring reporting, antivirus reporting, and other activity-based reporting for a wide array of other applications as well (such activities may be referred to herein as computing-related activities). Collectively, such concepts may be referred to herein as computing-related activities. As will also be recognized, this form or reporting can be applied to various areas outside the computing world, such as to real-world activities. Such real world events may include displaying patterns of crime to police investigators or displaying occurrences of activities during an emergency to emergencies to Federal Emergency Management Agency (FEMA) personnel. The primary examples provided herein are described in the context of Internet activities, but can be adapted to encompass any computing-related activities or real-world activities. Collectively, such concepts may be referred to herein as real-world activities. However, the concepts described herein are not necessarily to suggest policies, provide judgments, or make recommendations. Rather, the concepts may enable parents, for example, to understand how their children are using the Internet. Or, the concepts may enable employers to understand how their employees are using the Internet.

To do so, various embodiments may be employed to provide an awareness of “content” being accessed by users via the Internet (referred to as Internet activity, computing-related activity, and similar terms used herein interchangeably). The term content may refer to any uniform resource locator (URL), link, domain (e.g., top-level domain, second-level domain, third-level domain, etc.), website, webpage, search request, text, audio, advertisement, document, picture, music, review, video, book, information, and/or similar terms used herein interchangeably that may be accessed via the Internet. This information can be used to identify the source, e.g., website.

In one embodiment, a monitoring application and/or a reporting application can be implemented in a client-server context. In such an embodiment, a monitoring computing entity 105 can execute the monitoring application to record information/data about the Internet activity of various users. The monitoring computing entity 105 can provide the recorded information/data to a remote computing entity 100 executing the reporting application. The remote computing entity 100 executing the reporting application can then generate reports for interested parties regarding the recorded information/data.

Although the following description is provided in the client-server context, a variety of other approaches and techniques can be used to adapt to various needs and circumstances. For instance, the monitoring computing entity can execute a monitoring and a reporting application. Thus, the monitoring computing entity 105 can both monitor Interest usage and generate corresponding reports for interested parties. In another embodiment, the remote computing entity 100 can be positioned as a router or gateway (executing a monitoring and reporting application) through which Internet activity for one or more user computing entities passes. This embodiment may allow the remote computing entity 100 (executing a monitoring and reporting application) to monitor the Internet activity of user computing entities (e.g., users) whose traffic passes through the remote computing entity 105 (e.g., router, gateway) and generate corresponding reports for interested parties.

### 2. User Registration and Sign In

In one embodiment, as shown in FIG. 3, the process may begin by a user (e.g., operating a monitoring computing entity 105) registering with the monitoring application (Block 300 of FIG. 3). In one embodiment, registration may be carried out via the monitoring application that has been downloaded or preinstalled on the monitoring computing entity 105, for example. As part of the registration process, the user (e.g., operating a monitoring computing entity 105) may provide user information. User information may include a variety of information associated with the user, such as the user's first and last name, the user's address, the user's zip code, the user's mobile telephone number, email address, text message address, instant message address, a username, a password, an employee identification number, and/or the like.

In one embodiment, multiple users may share a single monitoring computing entity 105 to access the Internet, such as various family members sharing a home computer. Accordingly, each family member may register individually and have his or her own unique username and password. Thus, for instance after registering, as shown in FIG. 4, each time a user launches a browser or similar application to access content via the Internet, the user may be presented with a sign in screen. Generally, Internet access for the browser or other viewing applications (or all applications) is not permitted until the user is signed in. This allows information/data about the Internet activity or computing-related activity (and content accessed) to be attributed to the appropriate user.

In another embodiment, each monitoring computing entity 105 may be associated with or assigned to a single user, such as a business assigning each employee a monitoring computing entity 105. This often requires the user to sign in to the monitoring computing entity 105 to access the various business applications. In such an embodiment, signing in to the monitoring computing entity 105 may be used to automatically sign in the user to the monitoring application as well. Thus, for instance, each time a user launches a browser or similar application to access content via the Internet, the Internet activity or computing-related activity (and content accessed) can be attributed to the appropriate user.

In one embodiment, by requiring each individual user to sign in (or otherwise identifying each user), all Internet activity or computing-related activity (and content accessed) can be attributed to the appropriate users. In certain embodiments, given the attribution of the Internet activity or computing-related activity (and content accessed) to the signed in user, it may be beneficial for users sign out when they are done using the Internet. In one embodiment, this may be done through the system tray icon. In another embodiment, each time a browser or other viewing application is closed, the user may be automatically signed out by the monitoring computing entity 105. In still another embodiment, after a configurable period of inactivity (e.g., 30 minutes), the user may be automatically signed out by the monitoring computing entity 105.

### 3. Monitoring and Recording Information/Data

In one embodiment, when a user is signed in (or otherwise identified), the monitoring computing entity 105 (e.g., executing the monitoring application) can allow and monitor all Internet activity or computing-related activity (e.g. comprising content) to and from the monitoring computing entity 105. In a Microsoft Windows environment, for example, the monitoring application executing on the monitoring computing entity 105 can use Layered Service Provider (LSP) concepts to insert itself into the Transmission Control Protocol/Internet Protocol (TCP/IP) stack. Once in the TCP/IP stack, for instance, the monitoring application executing on the monitoring computing entity 105 (e.g., functioning as an LSP) can receive inbound and outbound Internet activity or computing-related activity (e.g. comprising content). This can allow the monitoring application executing on the monitoring computing entity 105 to monitor all outbound and inbound traffic. As will be recognized, a variety of other approaches and techniques can be used to adapt to various needs and circumstances.

In another embodiment, information/data recorded about real-world activities can be provided (e.g., transmitted) to the monitoring or reporting application periodically, regularly, continuously, or in response to certain triggers in a variety of ways. For example, the information/data recorded about real-world activities may be provided via upload or transmission of a file, message, or raw data that is understood by the monitoring or reporting application. The information/data recorded about real-world activities may include various information/data depending on the nature of the real-world activities. For instance, for crimes, the date, location, time, and other relevant details of the crimes may be included in the information/data recorded about real-world activities. As will be recognized, a variety of other approaches and techniques can also be used to adapt to various needs and circumstances.

The monitoring computing entity 105 (e.g., executing the monitoring application) can also record information/data about the Internet activity or computing-related activity (e.g., comprising content) by the signed in user (Block 305 of FIG. 3). The monitoring computing entity 105 may record such information/data periodically, regularly, continuously, or in response to certain triggers. For instance, by functioning as an LSP, the monitoring application executing on the monitoring computing entity 105 can record information/data of interest for relevant outbound and/or inbound traffic. To do so, the monitoring application executing on the monitoring computing entity 105 may distinguish between different types of Internet activity or computing-related activity, such as Internet activity or computing-related activity from email clients, browsers, viewing applications, background update processes of applications, games, and/or the like. In certain embodiments, Internet activity or computing-related activity to and from email clients, background update processes of applications, games, and/or the like may be disregarded by the monitoring application executing on the monitoring computing entity 105 (while in other embodiments information/data about such activities may be recorded). In other embodiments, such activity may be the primary activity of interest, such as with regard to monitoring an antivirus program. In a particular embodiment described herein, the monitoring application executing on the monitoring computing entity 105 generally records information/data about Internet activity or computing-related activity directed to and from a browser or similar viewing application, for example.

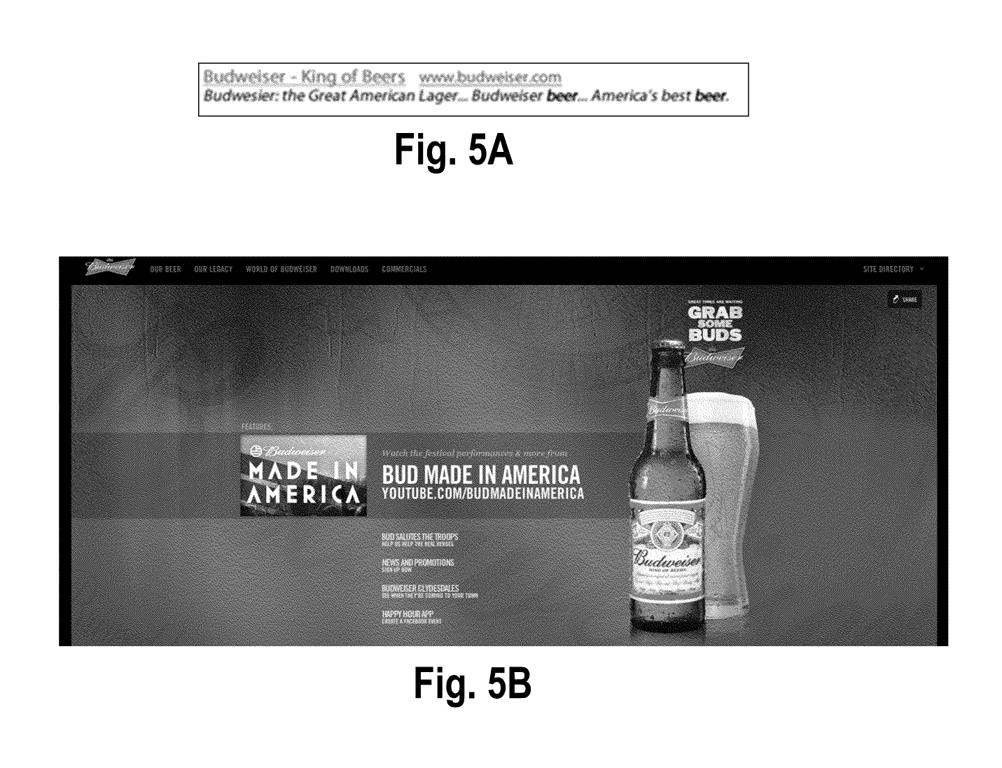

In one embodiment, recorded information/data about Internet activity or computing-related activity (e.g., comprising content) directed to and from a browser or similar viewing application may include URLs, links, domains (e.g., top-level domains, second-level domains, third-level domains, etc.), page titles, page snippets (e.g., screenshots, clippings, image captures, and/or the like), page descriptions (e.g., from META tags), and/or other relevant information. For instance, as shown in FIG. 5A, when a browser receives a webpage, the URL can also be recorded (www.budweiser.com). The title of the webpage can also be recorded (Budweiser—King of Beers), along with information about the webpage (Budweiser: the Great American Lager . . . Budweiser beer . . . America's best beer). And as shown in FIG. 5B, a screen shot or other clipping of the Budweiser page can be recorded from the source as well.

Additionally or alternatively, other details may also be recorded. For example, the monitoring application executing on the monitoring computing entity 105 can record information about a video viewed by the user via YouTube.com (whether embedded into a Budweiser webpage or accessed via YouTube directly). For example, the YouTube video may include content about how to brew your own beer (youtube.com/watch?v=5Lf2e_Oe54g). Similarly, search queries typed into search websites (or on non-search sites) can be recorded, as well as the results provided and results accessed. For instance, a search on google.com for the “best beer” can be recorded by the monitoring application executing on the monitoring computing entity 105. As will be recognized, a variety of other information/data can be recorded to adapt to various needs circumstances.

In one embodiment, recording information/data about Internet activity or computing-related activity to and from a browser or other viewing application (content accessed) may include determining the time the content was initially accessed (e.g., based on the time of the requests and responses), number of visits, and estimating the amount of time spent accessing the content (e.g., browsing, watching, or perusing the content). In one embodiment, determining the time the content was initially accessed may be based on the time of the request from the monitoring computing entity 105 or the time of the response to the monitoring computing entity 105. In estimating the amount of time spent accessing the content (e.g., browsing, watching, or perusing the content), the monitoring application executing on the monitoring computing entity 105 may need to distinguish between user-generated activities and entity-generated activities. User-generated activities may be when a user is actively engaging the monitoring computing entity 105, such as scrolling the screen, moving the mouse, depressing keys or other inputs, clicking links, requesting new webpages, and/or the like. Other activities indicative of user-generated activities may include audio or video playing via a website or determining that a browser or other viewing application is the current active window. Entity-generated activities may include webpages or advertisements refreshing or webpages reporting user statistics to the host website/source. By distinguishing between user-generated activities and entity-generated activities, the monitoring application executing on the monitoring computing entity 105 can estimate the amount of time spent accessing the content (e.g., webpage).

In one embodiment, the monitoring application executing on the monitoring computing entity 105 can estimate the time spent accessing the content as being the time from the initial request or provision of the content until one or more user-generated activities are no longer detected (or are no longer detected for specific time period, such as 70 seconds). By way of example, the time associated with accessing content via www.budweiser.com may be from the time of the initial request to or the time of the response from www.budweiser.com until the user closes the browser or tab, stops moving the mouse, or the corresponding browser or tab is no longer the current active pane or window.

Given that content may relate to a website or a webpage, the monitoring application executing on the monitoring computing entity 105 can estimate the time spent accessing the content and make distinctions, for example, between domains (e.g., second-level domains) and subdomains (e.g., third-level domains or lower). For instance, the monitoring application executing on the monitoring computing entity 105 may estimate that a user spent four hours over the past seven days accessing content via www.wikipedia.com. Of the four hours, the monitoring application executing on the monitoring computing entity 105 may estimate that 20 minutes was related to potato farming pages, while 3 hours and 40 minutes was related to webpages about different beers. Thus, each webpage (e.g., content) may be estimated and recorded separately.

In one embodiment, in addition to recording information/data about content accessed, the monitoring application executing on the monitoring computing entity 105 can also classify the content accessed by the user (along with the estimated time spent accessing the content) into one or more classifications (Block 310 of FIG. 3). In one embodiment, the monitoring application may include a classification engine that classifies the content accessed by a user. This classification may be done in real time before, after, or simultaneous to recording information/data about the content accessed and/or estimating the amount of time spent accessing the content. The classifications may be based on a configurable set of classifications. Such classifications may include “Adult,” “Alcohol,” “Drugs,” “Games,” “Hate,” “Online Games,” “Other,” “Shopping,” “Social Networking,” “Sports,” “Tobacco,” “Violence,” and/or the like. Such classifications may be based on a variety of factors associated with the content (e.g., website, webpage, etc.), including keywords in the text, colors in the content, graphical layout of the content, verbiage in the content, ratios in word usage in the content, and/or the like.

In another embodiment, the monitoring or reporting application can also classify the information/data recorded about the real-world activities into one or more classifications. In one embodiment, a classification engine can classify the information/data using a variety of customizable classifications similar to as described above with regard to the computing-related activities.

In one embodiment, the user may configure the monitoring application to only record information/data about content that is accessed (e.g., Internet activity or computing-related activity) that corresponds to specific classifications. For example, a parent may configure the monitoring application (e.g., by selecting from a menu of possible classifications) to only record information/data about content that is accessed (e.g., Internet activity or computing-related activity) that corresponds to Adult, Alcohol, Drugs, Tobacco, and Violence classifications. As will be recognized, content may overlap into one or more classifications. For example, a user may access content via www.wikipedia.com. On www.wikipedia.com, the user may access a variety of content from, for example, potato farming to home breweries. Thus, a user's activity on www.wikipedia.com may be classified into more than one classification: (1) the potato farming content accessed via www.wikipedia.com may be classified in the Other Classification and (2) the home brewery content accessed via www.wikipedia.com may be classified in the Alcohol Classification. Moreover, subdomains (e.g., third-level domains or lower), individual webpages, or videos (e.g., content) may also be classified into more than one classification.

In one embodiment, the information/data recorded about Internet activities or computing-related activities can be provided (e.g., transmitted) by the monitoring application executing on the monitoring computing entity 105 to the reporting application executing on the remote computing entity 100 periodically, regularly, continuously, or in response to certain triggers. The information/data recorded about Internet activities or computing-related activities may include (a) URLs, links, domain names, page titles, page snippets, and/or page descriptions for content accessed, (b) the time the content was initially accessed, the number of visits to the content (e.g., number of times the source was accessed), and/or the estimated amount of time spent accessing the content, (c) one or more classifications for the content, and/or (d) the like.

### D. Providing Alerts and Reports

As previously noted, the primary examples provided herein are described in the context of Internet activities, but can adapted to encompass any computing-related activities or real-world activities. In one embodiment, the reporting application executing on the remote computing entity 100 can generate alerts and/or reports periodically, regularly, continuously, or in response to certain triggers (Block 315 of FIG. 3). To do so, each classification may be associated with a configurable “severity” level. Table 1 below provides exemplary classifications and the corresponding configurable severity levels.

TABLE 1

| Classification | Severity Level |
|---|---|
| Adult | High |
| Alcohol | Medium |
| Drugs | High |
| Games | Low |
| Hate | High |
| Online Games | Low |
| Other | Low |
| Shopping | Low |
| Social Networking | Low |
| Sports | Low |
| Tobacco | Medium |
| Violence | High |

As can be seen from Table 1, each classification is associated with a specific severity level. For instance, the Adult Classification is associated with a High Severity Level, while the Sports Classification is associated with a Low Severity Level. As will be recognized, a user may modify the severity level associated with each classification, such as changing the Alcohol Classification from a Medium Severity Level to a High Severity Level (e.g., by selecting from a menu of severity levels).

In one embodiment, a user can be automatically provided with alerts about the Internet activity or computing-related activity meeting or exceeding specific severity levels. To do so, a user can configure for what, when, and to where alerts should be provided about specific Internet activities or computing-related activities (e.g., content accessed). For example, a user may provide a configuration that text messages should be provided to her mobile phone number for any Internet activities or computing-related activities (content accessed) associated with a High Severity Level: John Smith may configure the appropriate computing entity to provide text messages to 555.555.1212 for any Internet activity or computing-related activity that corresponds to a High Severity Level. Thus, when the reporting application executing on the remote computing entity 100 receives an indication that a user accessed content classified as being Adult (e.g., meeting the High Severity Level), the reporting application executing on the remote computing entity 100 can provide a text message to 555.555.1212 regarding the same. As will be recognized, a variety of other approaches and techniques may also be used to adapt to various needs and circumstances.

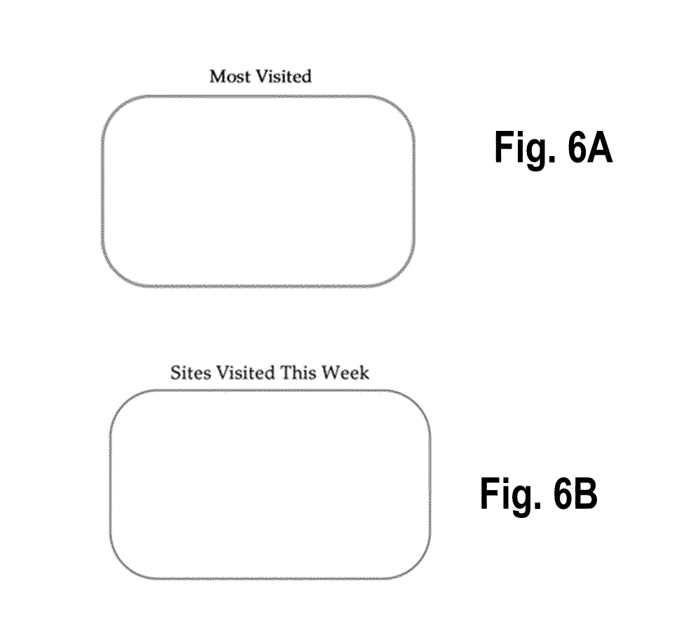

In addition to providing alerts, the reporting application executing on the remote computing entity 100 can generate reports periodically, regularly, continuously, or in response to certain triggers. For example, reports can be generated every 15 minutes or in response to a request from a user. As shown in FIGS. 6A, 6B, 7, and 8, the reports comprise a variety of novel features. As is described in greater detail below, the reports can be designed to aggregate the results, highlight potential trouble areas based on severity levels, and highlight changes in a user-friendly manner.

In one embodiment, a report can be generated for a configurable reporting time period. For example, a report can be configured to span a few hours, days, weeks, months, and/or the like (as determined from the initiation of the report). The following examples will describe reports spanning a seven-day period. In one embodiment, the reporting application executing on the remote computing entity 100 may allow a user to configure the reporting time period to which a report corresponds. Moreover, a report may be for one or more user's Internet activities (such as a user group, department, or physical location of an employer) or one or more computing-related activities. Similarly, the report may be for one or more real-world activities.

In one embodiment, each report can aggregate (and provide in one or more objects of a report) usage information/data and assessment information/data about the Internet activities, computing-related activities (content accessed), or real world activities based on the classifications. Further, such reports may be comprehensive because the information/data recorded about Internet activities or computing-related activities (e.g., content accessed) may include (a) URLs, links, domains (e.g., top-level domains, second-level domains, third-level domains, etc.), page titles, page snippets, and/or page descriptions for content accessed, (b) the time the content was initially accessed, the number of visits to the content (e.g., number of times the source was accessed), and/or the estimated amount of time spent accessing the content, (c) one or more classifications for the content, and/or (d) the like.

In one embodiment, the reporting application executing on the remote computing entity 100 can aggregate (and provide in one or more objects of a report) information/data recorded about the Internet activity, computing-related activity (content accessed), or real-world activity for the last seven days, for example. In one embodiment, recorded information/data can be first aggregated based on the classifications of the content, which classifications for the content accessed were provided by the monitoring application executing on the monitoring computing entity 105. For example, the information/data recorded about the Internet activity or computing-related activity (e.g., content) classified as being associated with the Adult Classification can be aggregated together, information/data about the Internet activity or computing-related activity classified as being associated with the Alcohol Classification can be aggregated together, information/data about the Internet activity or computing-related activity classified as being associated with the Drugs Classification can be aggregated together, and so on (e.g., Games Classification, Hate Classification, Online Games Classification, Other Classification, Shopping Classification, Social Networking Classification, Sports Classification, Tobacco Classification, Violence Classification, and/or the like). As previously discussed, a user's activity on www.wikipedia.com, for example, may be classified into more than one classification: (1) the potato farming content accessed via www.wikipedia.com may be classified in the Other Classification and (2) the home brewery content accessed via www.wikipedia.com may be classified in the Alcohol Classification. It should be noted that aggregation essentially can serve as a filtering function by grouping content of like classifications.

In one embodiment, the reporting application may be configurable to only generate (and/or cause display of) reports with information/data recorded that corresponds to specific classifications. For example, a parent may configure the reporting application (e.g., by selecting from a menu of classifications) to only report information/data recorded about Internet activity or computing-related activity (e.g., content accessed) that corresponds to the Adult Classification, Alcohol Classification, Drugs Classification, Tobacco Classification, and Violence Classification. As will be recognized, a variety of other approaches and techniques may be used to adapt to various needs and circumstances.

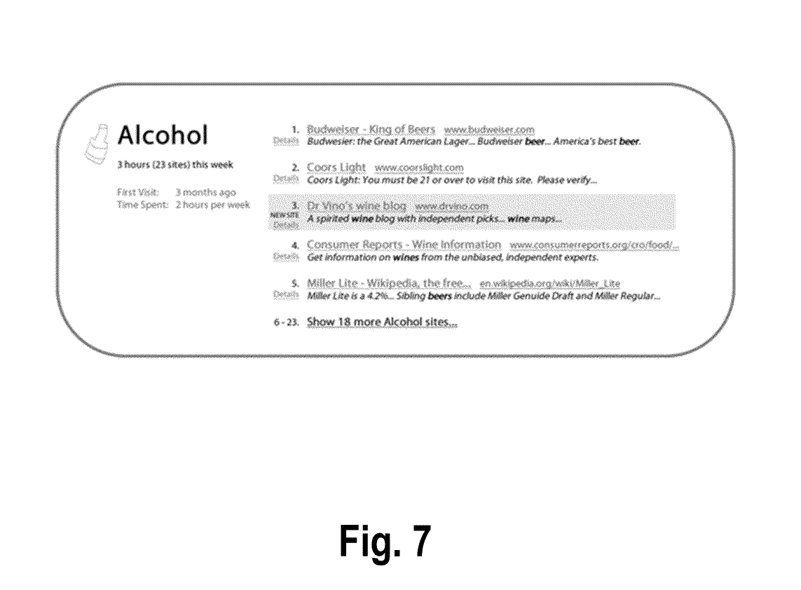

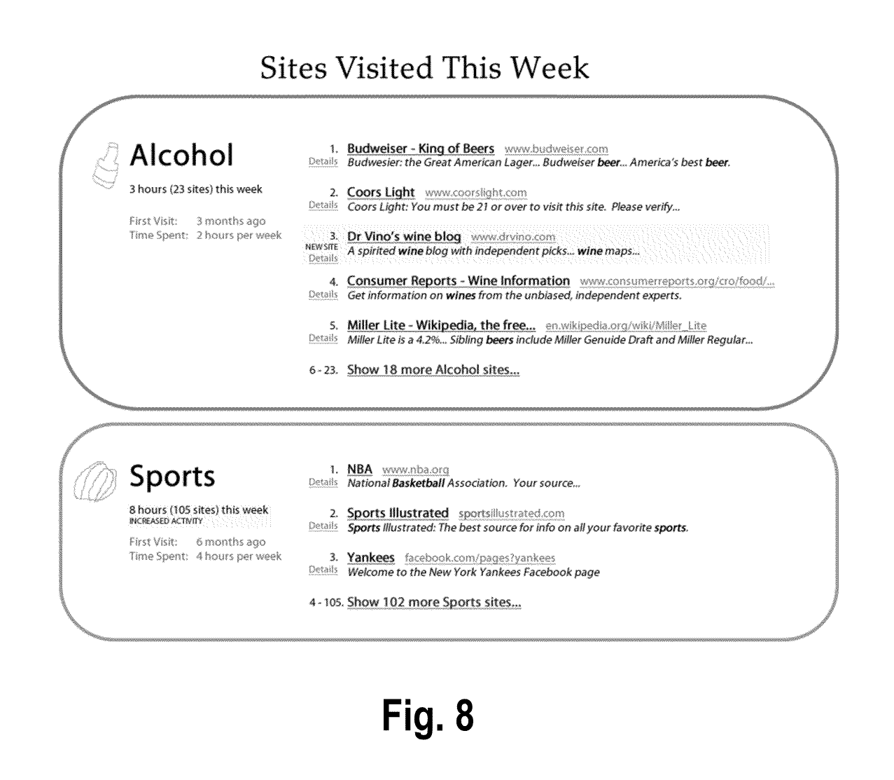

In one embodiment, aggregating usage information/data about Internet activity or computing-related activity (content accessed) may include determining (and/or causing display of) the total number of sites visited (e.g., sources accessed) by the user for the configurable reporting time period (e.g., seven days) or since monitoring began. This may be facilitated because the information/data recorded about Internet activities or computing-related activities (e.g., content accessed) may include URLs, links, domains (e.g., top-level domains, second-level domains, third-level domains, etc.), page titles, and/or page descriptions for content accessed. Thus, the reporting application executing on the remote computing entity 100 may simply determine the total number of websites (e.g., unique second-level domains) visited by the user for the configurable reporting time period (e.g., seven days) or since monitoring began. In this particular example, webpages are considered as part of a website/source. Accordingly, visiting 12 webpages via the www.budweiser.com domain may be considered a visit to a single website/source. And each time a user returns to the www.budweiser.com domain may be considered another website/source visit. So for example, the usage information/data shown in FIGS. 7 and 8 indicates that 23 websites classified in the Alcohol classification were visited during the reporting time period. And 105 websites classified in the Sports classification were visited during the reporting time period.

In one embodiment, aggregating usage information/data about Internet activity or computing-related activity (content accessed) may include determining (and/or causing display of) when the first visit to a website/source corresponding to each classification occurred. This may be facilitated because the information/data recorded about Internet activities or computing-related activities (e.g., content accessed) may include the time the content was initially accessed. Thus, for example, the reporting application executing on the remote computing entity 100 may simply identify the content (e.g., website or webpage) that was first visited for one or more classifications by the user for the configurable reporting time period (e.g., seven days) or since monitoring began. Continuing with the above example, the usage information/data shown in FIGS. 7 and 8 indicates that the first visit to content (e.g., a website/source) classified in the Alcohol Classification was three months ago, and the first visit to content (e.g., a website/source) classified in the Sports Classification was six months ago.

In one embodiment, aggregating usage information/data about Internet activity or computing-related activity (content accessed) may include determining (and/or causing display of) the estimated amount of time spent accessing content (Internet activity or computing-related activity) for each classification for the configurable reporting time period (e.g., seven days) or since monitoring began. This may be facilitated because the information/data recorded about Internet activities or computing-related activities (e.g., content accessed) may include the estimated amount of time spent accessing the content. Accordingly, the reporting application executing on the remote computing entity 100 may simply aggregate the estimated amount of time spent accessing the websites or webpages (e.g., content) for a classification to determine the total estimated amount of time spent accessing content associated with the classification for the configurable reporting time period (e.g., seven days) or since monitoring began. Continuing with the above example, the usage information/data shown in FIGS. 7 and 8 indicates that the estimated amount of time spent accessing content (e.g., websites, webpages, etc.) classified in the Alcohol Classification was two hours, and the estimated amount of time spent accessing content (e.g., websites, webpages, etc.) classified in the Sports Classification was four hours. Similarly, averages, medians, modes, and/or the like related to the time spent accessing content can also be determined by the reporting application executing on the remote computing entity 100.

In one embodiment, the reporting application executing on the remote computing entity 100 can aggregate (and provide in one or more objects of a report) assessment information/data about the Internet activity or computing-related activity (content accessed) for the last seven days, for example. In one embodiment, aggregating assessment information/data about the Internet activity or computing-related activity (content accessed) may include aggregating content accessed via a single website or domain (e.g., second-level domain) corresponding to a specific classification. As previously discussed, webpages of a website or subdomains of a domain may corresponded to different classifications and therefore be associated with different severity levels. Thus, not all webpages for a given website or subdomains for a given domain will be aggregated (and provided in one or more objects of a report) together. Only the webpages for a given website with the same classification or subdomains for a given domain with the same classification will be aggregated (and provided in one or more objects of a report) together. This may be facilitated because the information/data recorded about Internet activities or computing-related activities (e.g., content accessed) may include URLs, links, domains (e.g., top-level domains, second-level domains, third-level domains, etc.), page titles, and/or page descriptions for content accessed. In one embodiment, for each classification, content accessed via a single domain (e.g., webpages of website or subdomains of a domain) can be aggregated (and provided in one or more objects of a report) together. For example, all webpages visited via the www.budweiser.com domain can be aggregated (and provided in one or more objects of a report) and so forth. This allows the reporting application executing on the remote computing entity 100 to aggregate all the related to www.budweiser.com Internet activity or computing-related activity together. In various embodiments, this can provide the user with a more user-friendly view of the Internet activity or computing-related activity grouped by domain or website. As will be recognized, during display, the aggregated information/data related to www.budweiser.com can be expanded for more detailed view (not shown). In the more detailed view, for each webpage accessed, for example, the reporting application executing on the remote computing entity 100 can provide (a) the URL, the page title, a page snippet, and/or a page description, (b) the time the content was initially accessed, the number of visits to the content (e.g., number of times the source was accessed), and/or the estimated amount of time spent accessing the content, (c) one or more classifications for the content, and/or (d) the like. It should be noted that aggregation essentially can serve as a filtering function by grouping content from the same second-level domains, for example.

As will be recognized, this approach can allow the user to view three different levels of reporting granularity: classification, website/source, and webpage (or individual content). For instance, the report may indicate that a user spent two hours accessing content associated with the Alcohol Classification, 48 minutes accessing content via www.budweiser.com, and 8 minutes accessing content at http://www.budweiser.com/summersale.html.

In one embodiment, as part of generating a report, the reporting application executing on the remote computing entity 100 can provide for various formatting options to highlight potential trouble, trends, and/or change. The potential trouble, trends, and/or change may be based on classifications and corresponding severity levels, frequency of visits, amount of time spent, and/or the like. Such potential trouble, trends, and/or change may be highlighted with miniature graphs, sparklines, different or larger fonts, different text or background colors, and/or the like.

In one embodiment, the reporting application executing on the remote computing entity 100 can generate an object for each classification and corresponding content. An object may be an interactive graphic, text box, image, heading, shape, table, diagram, and/or the like. FIGS. 6A and 6B are exemplary blank objects that can be populated. FIG. 7 is an exemplary object for the Alcohol Classification (and corresponding content) for a given report. And FIG. 8 includes exemplary objects for the Alcohol Classification (and corresponding content) and the Sports Classification (and corresponding content) for a given report. In one embodiment, some or all of an object may be color coded based on severity levels (not shown). For example, objects associated with a High Severity Level can be outlined in red, objects associated with a Medium Severity Level can be outlined in yellow, and objects associated with a Low Severity Level can be outlined in green. In one embodiment, objects within a report can be ordered based on severity levels, frequency of visits (e.g., number of times accessed), amount of time spent, chronologically, alphabetically, and/or the like. For example, objects with associated a High Severity Level can be ordered first in the report. As will be recognized, a variety of other approaches and techniques can be used to adapt to various needs and circumstances.

As can be seen from both FIGS. 7 and 8, not all websites (e.g., content) associated with each classification are shown in this particular view of the report (e.g., in the object). This is because the reporting application executing on the remote computing entity 100 may have a configurable display limit for content associated with the classification. For example, the configurable display limit may allow a user to indicate that only information/data for three or five domains (e.g., second-level domains) or websites should be initially provided in the corresponding object. This may provide the user with a simplified view of the Internet activities or computing-related activities for the classification via an object, while allowing the user to drill down for additional information/data about each website or domain by selecting or clicking on “Details” or each classification by selecting or clicking “Show 18 more Alcohol sites” or “Show 102 more Sports sites” as shown in FIGS. 7 and 8. Thus, both information/data about websites or domains and classifications can be drilled down. Drilling down into a specific website or domain in an object may provide with user with information/data recorded, such as URLs, links, domains, page titles, page snippets, and/or page descriptions for the corresponding content. In one embodiment, the URLs, links, domains, page titles, page snippets, and/or page descriptions for the corresponding content can be hyperlinked such that the viewer of the report can be taken to the actual content accessed. As will recognized, a variety of other approaches and techniques can be used to adapt to various needs and circumstances.

In one embodiment, the reporting application executing on the remote computing entity 100 can provide for various other formatting options to highlight specific content. For example, the domains or websites for each classification can also be ordered based on a “ranking,” for example. The ranking may be used to merely indicate the order in which the domains (e.g., second-level domains) or websites should be displayed within an object for the classification. The ranking may be used to indicate that new domains or websites (e.g., second-level domains or websites that have not been visited before) should be first followed by domains or websites in order of number of times visited/accessed or time spent on the domains or websites (an efficient way to keep track of which sites (or categories) have been visited before is by using a data structure known as a Bloom filter). In another embodiment, the ranking may indicate that the domains or websites that most likely relate to the associated classification should be ordered first followed by domains or websites in order of number of times visited/accessed or time spent on the domains or websites. Further, websites or domains in an object can be ordered based on frequency of visits (e.g., number of times accessed), amount of time spent, chronologically, alphabetically, and/or the like. As will be recognized, a variety of other approaches and techniques can be used to adapt to various needs and circumstances.

In one embodiment, the reporting application executing on the remote computing entity 100 can provide for various other formatting options, such as changing the text color, size, or font; changing the background color, bolding, underlining, using miniature graphs sparklines, and/or the like. For example, new domains or websites (e.g., second-level domains or websites that have not been visited before) for a classification can be provided in the object in a different text or background color, bolded, underlined, and/or the like. Similarly, domains or websites visited most frequently or on which the most time was spent can be provided in the in a different text or background color, bolded, underlined, and/or the like. Such features may be configurable and used to draw a user's attention to highlight potential trouble, trends, and/or change. As will be recognized, a variety of other approaches and techniques can be used to adapt to various needs and circumstances.

After a report is generated, the reporting application executing on the remote computing entity can provide the report to the appropriate computing entity. This may include transmitting, sending, and/or causing display of the report using various electronic formats.

As previously noted, such reports may be generate in a similar fashion for a variety of other objectives as well. For example, such reports can be generated in a similar manner for security monitoring reporting, antivirus reporting, and other activity-based reporting for a wide array of other applications as well. Thus, as will be recognized, a variety of other approaches and techniques can be used to adapt to various needs and circumstances.

### IV. CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method for monitoring and reporting computing-related activities, the method comprising:
receiving, via one or more processors, data associated with a plurality of computing-related activities, wherein each of the plurality computing-related activities is associated with a classification from a plurality of classifications;
generating, via the one or more processors, a report for a time period based at least in part on the plurality of computing-related activities, wherein generating the report comprises:
aggregating each of the computing-related activities into the respective plurality of classifications,
for each of the respective plurality of classifications, aggregating the corresponding data associated with the plurality of computing-related activities for the classification by source, and
generating an object for each of the respective plurality of classifications, wherein each object comprises data associated with the corresponding computing-related activities for the classification aggregated by source, and
providing the report.

2. The method of claim 1, wherein each of the plurality of classifications is associated with a severity level.

3. The method of claim 2 further comprising ordering the respective objects in the report based on severity level.

4. The method of claim 1, wherein the corresponding data associated with the plurality computing-related activities of the object for each of the respective plurality of classifications is further formatted by most frequent computing-related activities.

5. The method of claim 1, wherein the report comprises an indication for new computing-related activities.

6. The method of claim 1 further comprising:
determining whether at least one of the plurality of computing-related activities satisfies a predetermined severity level; and
after a determination that at least one of the plurality of computing-related activities satisfies a predetermined severity level, providing an alert indicating that the at least one of the plurality of computing-related activities satisfies the predetermined severity level.

7. The method of claim 1, wherein (a) the plurality computing-related activities comprise Internet activities of one or more users and (b) the data associated with the corresponding Internet activities comprise snippets of webpages visited.

8. The method of claim 1, wherein the respective plurality of classifications in the report are further formatted by at least one of usage time, frequency, or number of occurrences.

9. The method of claim 1, wherein the data associated with the corresponding computing-related activities for the classification aggregated by source are further formatted by at least one of usage time, frequency, or number of occurrences.

10. The method of claim 1, wherein (a) the plurality computing-related activities comprise Internet activities of one or more users and (b) the data associated with the corresponding Internet activities comprise at least one of snippets or descriptions of Internet content accessed.

11. The method of claim 1, wherein (a) the plurality computing-related activities comprise network security activities and (b) the data associated with the corresponding network security activities comprise at least one of frequency or number of occurrences.

12. An apparatus comprising at least one processor and at least one memory including computer program code, the at least one memory and the computer program code configured to, with the processor, cause the apparatus to at least:
receive data associated with a plurality of computing-related activities, wherein each of the plurality computing-related activities is associated with a classification from a plurality of classifications;
generate a report for a time period based at least in part on the plurality of computing-related activities, wherein generating the report comprises:
aggregating each of the computing-related activities into the respective plurality of classifications,
for each of the respective plurality of classifications, aggregating the corresponding data associated with the plurality of computing-related activities for the classification by source, and
generating an object for each of the respective plurality of classifications, wherein each object comprises data associated with the corresponding computing-related activities for the classification aggregated by source, and
provide the report.

13. The apparatus of claim 12, wherein each of the plurality of classifications is associated with a severity level.

14. The apparatus of claim 13, wherein the memory and computer program code are further configured to, with the processor, cause the apparatus to order the respective objects in the report based on severity level.

15. The apparatus of claim 12 wherein the corresponding data associated with the plurality computing-related activities of the object for each of the respective plurality of classifications is further formatted by most frequent computing-related activities.

16. The apparatus of claim 12, wherein the report comprises an indication for new computing-related activities.

17. The apparatus of claim 12, wherein the corresponding data associated with the plurality computing-related activities of the object for each of the respective plurality of classifications is further formatted by usage time of the computing-related activities.

18. The apparatus of claim 12, wherein the memory and computer program code are further configured to, with the processor, cause the apparatus to:
determine whether at least one of the plurality of computing-related activities satisfies a predetermined severity level; and
after a determination that at least one of the plurality of computing-related activities satisfies a predetermined severity level, provide an alert indicating that the at least one of the plurality of computing-related activities satisfies the predetermined severity level.

19. The apparatus of claim 12, wherein the respective plurality of classifications in the report are further formatted by at least one of usage time, frequency, or number of occurrences.

20. The apparatus of claim 12, wherein the data associated with the corresponding computing-related activities for the classification aggregated by source are further formatted by at least one of usage time, frequency, or number of occurrences.

21. The apparatus of claim 12, wherein (a) the plurality computing-related activities comprise Internet activities of one or more users and (b) the data associated with the corresponding Internet activities comprise at least one of snippets or descriptions of Internet content accessed.

22. The apparatus of claim 12, wherein (a) the plurality computing-related activities comprise network security activities and (b) the data associated with the corresponding network security activities comprise at least one of frequency or number of occurrences.

23. A computer program product for monitoring and reporting user activities, the computer program product comprising at least one non-transitory computer-readable storage medium having computer-readable program code portions stored therein, the computer-readable program code portions comprising:
an executable portion configured to receive data associated with a plurality of computing-related activities, wherein each of the plurality computing-related activities is associated with a classification from a plurality of classifications;
an executable portion configured to generate a report for a time period based at least in part on the plurality of computing-related activities, wherein generating the report comprises:
aggregating each of the computing-related activities into the respective plurality of classifications,
for each of the respective plurality of classifications, aggregating the corresponding data associated with the plurality of computing-related activities for the classification by source, and
generating an object for each of the respective plurality of classifications, wherein each object comprises data associated with the corresponding computing-related activities for the classification aggregated by source, and
an executable portion configured to provide the report.

24. The computer program product of claim 23, wherein each of the plurality of classifications is associated with a severity level.

25. The computer program product of claim 24 further comprising an executable portion configured to order the respective objects in the report based on severity level.

26. The computer program product of claim 23, wherein the corresponding data associated with the plurality computing-related activities of the object for each of the respective plurality of classifications is further formatted by most frequent computing-related activities.

27. The computer program product of claim 23, wherein the report comprises an indication for new computing-related activities.

28. The computer program product of claim 23, wherein the corresponding data associated with the plurality computing-related activities of the object for each of the respective plurality of classifications is further formatted by usage time of the computing-related activities.

29. The computer program product of claim 23 further comprising:
an executable portion configured to determine whether at least one of the plurality of computing-related activities satisfies a predetermined severity level; and
an executable portion configured to after a determination that at least one of the plurality of computing-related activities satisfies a predetermined severity level, provide an alert indicating that the at least one of the plurality of computing-related activities satisfies the predetermined severity level.

30. The computer program product of claim 23, wherein the respective plurality of classifications in the report are further formatted by at least one of usage time, frequency, or number of occurrences.

31. The computer program product of claim 23, wherein the data associated with the corresponding computing-related activities for the classification aggregated by source are further formatted by at least one of usage time, frequency, or number of occurrences.

32. The computer program product of claim 23, wherein (a) the plurality computing-related activities comprise Internet activities of one or more users and (b) the data associated with the corresponding Internet activities comprise at least one of snippets or descriptions of Internet content accessed.

33. The computer program product of claim 23, wherein (a) the plurality computing-related activities comprise network security activities and (b) the data associated with the corresponding network security activities comprise at least one of frequency or number of occurrences.

34. A method for reporting activities, the method comprising:
generating, via one or more processors, a report for a time period corresponding to a plurality of activities, wherein (a) each of the plurality of activities is associated with a classification from a plurality of classifications and (b) generating the report comprises:
aggregating each of the plurality of activities into the respective plurality of classifications, and
generating an object for each of the respective plurality of classifications, wherein each object comprises data associated with the corresponding activities, and
providing, via the one or more processors, the report.

35. The method of claim 34, wherein each of the plurality of classifications is associated with a severity level.

36. The method of claim 35 further comprising ordering the respective objects in the report based on severity level.

37. The method of claim 34, wherein the respective plurality of classifications in the report are further formatted by at least one of frequency or number of occurrences.

38. A computer program product for reporting activities, the computer program product comprising at least one non-transitory computer-readable storage medium having computer-readable program code portions stored therein, the computer-readable program code portions comprising:
an executable portion configured to generate a report for a time period corresponding to a plurality of activities, wherein (a) each of the plurality of activities is associated with a classification from a plurality of classifications and (b) generating the report comprises:
aggregating each of the plurality of activities into the respective plurality of classifications, and
generating an object for each of the respective plurality of classifications, wherein each object comprises data associated with the corresponding activities, and
an executable portion configured to provide the report.

39. The computer program product of claim 38, wherein each of the plurality of classifications is associated with a severity level.

40. The computer program product of claim 39 further comprising ordering the respective objects in the report based on severity level.

41. The computer program product of claim 38, wherein the respective plurality of classifications in the report are further formatted by at least one of frequency or number of occurrences.
